(19) United States
(12) Patent Application Publication
(10) Pub. No.: US 2024/0420721 A1
(43) Pub. Date: Dec. 19, 2024

(54) AUDIO PROCESSING METHOD, AUDIO PROCESSING SYSTEM, AND PROGRAM

(71) Applicant: Yamaha Corporation, Hamamatsu (JP)

(72) Inventors: Yu TAKAHASHI, Hamamatsu (JP); Kenji ISHIZUKA, Hamamatsu (JP)

(21) Appl. No.: 18/821,808

(22) Filed: Aug. 30, 2024

Related U.S. Application Data
(63) Continuation of application No. PCT/JP2022/009774, filed on Mar. 7, 2022.

(51) Int. Cl. G10L 21/0272

(52) U.S. Cl. CPC G10L 21/0272

(57) ABSTRACT

An audio processing method that is realized by a computer system includes acquiring a first audio signal including percussive components and non-percussive components, and serially executing a plurality of stages of adaptive notch filter processing on the first audio signal, thereby generating a second audio signal in which the non-percussive components in the first audio signal are suppressed.

### CROSS-REFERENCE TO RELATED APPLICATIONS

This application is a continuation application of International Application No. PCT/JP2022/009774, filed on Mar. 7, 2022. The entire disclosures of International Application No. PCT/JP2022/009774 are hereby incorporated herein by reference.

### BACKGROUND

### Technological Field

The present disclosure relates to a technology for processing audio signals.

### Background Information

Techniques for separating specific acoustic components contained in audio signals have been proposed in the prior art. For example, Ono et al., “Harmonic and Percussive Sound Separation and its Application to MIR-related Tasks,” Springer 274, pp. 213-236, 2010. discloses a technique for separating an audio signal into harmonic components and non-harmonic components, using the anisotropism that harmonic components are continuous along the time axis while non-harmonic components are continuous along the frequency axis direction. In addition, Japanese Laid-Open Patent Application No. 2003-122368 also discloses a configuration in which an audio signal is separated into harmonic and non-harmonic components. Specifically, an audio signal is delayed by half a pitch period to generate a delayed signal. The delayed signal is subtracted from audio signal to generate non-harmonic components, and the audio signal and the delayed signal are added to generate harmonic components.

### SUMMARY

In the technique of Ono et al., “Harmonic and Percussive Sound Separation and its Application to MIR-related Tasks,” Springer 274, pp. 213-236, 2010, a process of analyzing a plurality of frames is necessary to evaluate continuousness in the time axis direction. Therefore, a processing delay corresponding to the number of frames to be analyzed inevitably occurs. In addition, in the technique of Japanese Laid-Open Patent Application No. 2003-122368, it is essential to estimate the fundamental frequency of the audio signal in order to generate the delayed signal. Accordingly, if the estimation accuracy of the fundamental frequency is low, there is the problem that the harmonic components and the non-harmonic components cannot be separated with high accuracy.

In the description above, attention is focused on the separation of harmonic components and non-harmonic components for the sake of convenience, but the same issues can be anticipated in any scenario in which particular acoustic components included in an audio signal are separated. In consideration of such circumstances, an object of one aspect of the present disclosure is to separate particular acoustic components of an audio signal with high accuracy while reducing processing delays.

In order to solve the problem described above, an audio processing method according to one aspect of the present disclosure comprises, acquiring a first audio signal including percussive components and non-percussive components, and serially executing a plurality of stages of adaptive notch filter processing on the first audio signal, thereby generating a second audio signal in which the non-percussive components in the first audio signal are suppressed.

An audio processing system according to one aspect of the present disclosure comprises an electronic controller including at least one processor configured to acquire a first audio signal including percussive components and non-percussive components, and serially execute a plurality of stages of adaptive notch filter processing on the first audio signal, thereby generating a second audio signal in which the non-percussive components in the first audio signal are suppressed.

A non-transitory computer-readable medium storing a program according to one aspect of the present disclosure causes a computer system to execute a process that comprises acquiring a first audio signal including percussive components and non-percussive components, and serially executing a plurality of stages of adaptive notch filter processing on the first audio signal, thereby generating a second audio signal in which the non-percussive components in the first audio signal are suppressed.

### BRIEF DESCRIPTION OF THE DRAWINGS

FIG. 1 is a block diagram showing a configuration of an audio processing system.

FIG. 2 is an explanatory diagram of percussive components and non-percussive components.

FIG. 3 is a block diagram showing a configuration of a signal processing unit.

FIG. 4 is a block diagram showing a configuration of an audio processing unit.

FIG. 5 is a block diagram showing a configuration of an adaptive notch filter.

FIG. 6 is a block diagram showing a configuration of an output control unit.

FIG. 7 is a flowchart showing a procedure of a process executed by a control device.

FIG. 8 is a block diagram showing a configuration of a signal processing unit in a second embodiment.

FIG. 9 is a block diagram showing configurations of a first audio processing unit, a second audio processing unit, and a signal synthesizing unit.

FIG. 10 is a flowchart showing a procedure of a process executed by a control device of the second embodiment.

### DETAILED DESCRIPTION OF THE EMBODIMENTS

Selected embodiments will now be explained in detail below, with reference to the drawings as appropriate. It will be apparent to those skilled in the field from this disclosure that the following descriptions of the embodiments are provided for illustration only and not for the purpose of limiting the invention as defined by the appended claims and their equivalents.

### A: First Embodiment

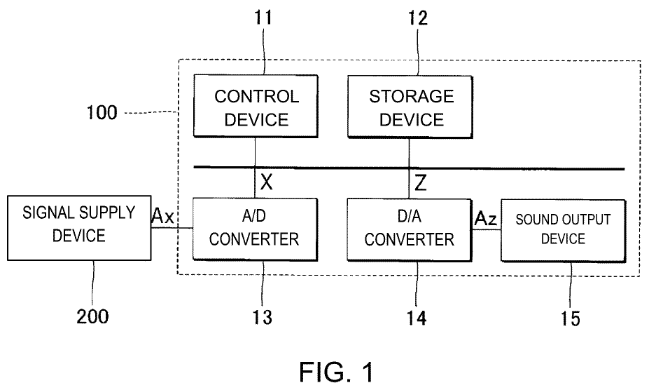

FIG. 1 is a block diagram showing a configuration of an audio processing system 100 according to a first embodiment. A signal supply device 200 is connected to the audio processing system 100. The signal supply device 200 is a signal source that supplies an audio signal Ax to the audio processing system 100. The audio signal Ax is an analog signal in the time domain representing an audio waveform, such as a musical sound or a voice.

For example, a reproduction device that supplies, to the audio processing system 100, the audio signal Ax stored in a storage medium, or a communication device that supplies, to the audio processing system 100, the audio signal Ax received from a distribution device (not shown) via a communication network, can be used as the signal supply device 200. In addition, a sound collection device that collects surrounding sounds to generate the audio signal Ax is also used as the signal supply device 200. For example, a sound collection device collects musical instrument sounds produced by a musical instrument played by a user, or voice produced by a user singing. Additionally, an electric musical instrument that supplies, to the audio processing system 100, the audio signal Ax corresponding to a user's performance can be used as the signal supply device 200. The electric musical instrument is a string instrument such as an electric guitar or an electric bass.

The audio processing system 100 comprises a control device 11, a storage device 12, an A/D converter 13, a D/A converter 14, and a sound output device 15. The audio processing system 100 can be realized as a single device, or as a plurality of devices which are separately configured. The signal supply device 200 can be provided in the audio processing system 100.

The A/D converter 13 converts the analog audio signal Ax into a digital audio signal X. That is, the audio signal X is a time series of samples representing an audio waveform. A digital audio signal X can be supplied from the signal supply device 200 to the audio processing system 100. The audio signal X is one example of the “first audio signal.”

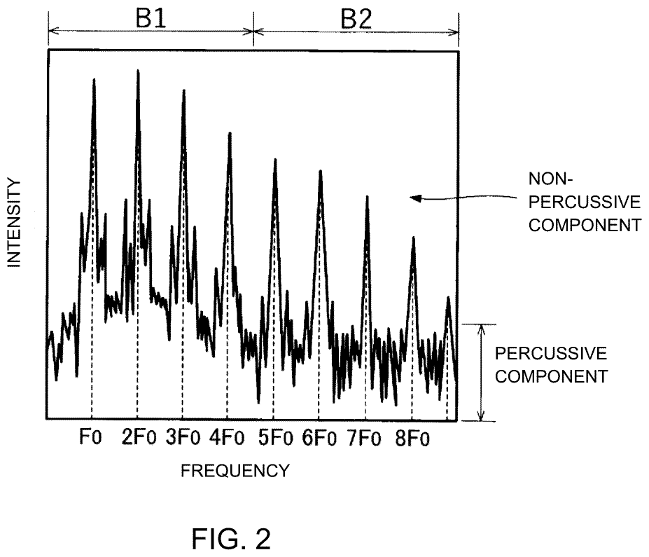

FIG. 2 shows an intensity spectrum of the audio signal X. The audio signal X includes percussive components and non-percussive components. Non-percussive components are acoustic components in which the signal strength (energy) in the frequency domain is locally high compared to its surroundings. In the first embodiment, a plurality of harmonic components that includes fundamental components and overtone components are assumed as the non-harmonic components. The frequency of each harmonic component is an integer multiple of fundamental frequency F0. On the other hand, percussive component are acoustic components that are continuously distributed over a wide range in the frequency domain. Specifically, the percussive components are non-harmonic components other than the harmonic components. Percussive components tend to decay in a shorter time as compared with non-percussive components. For example, a performance sound of a percussion instrument is a typical example of a percussive component.

The control device 11 (electronic controller) of FIG. 1 is one or a plurality of processors that control each element of the audio processing system 100. Specifically, the control device 11 includes one or more types of processors, such as a CPU (Central Processing Unit), a GPU (Graphics Processing Unit), an SPU (Sound Processing Unit), a DSP (Digital Signal Processor), an FPGA (Field Programmable Gate Array), an ASIC (Application Specific Integrated Circuit), and the like. The control device 11 of the first embodiment separately processes the percussive components and the non-percussive components in the audio signal X to generate a digital audio signal Z. The term “electronic controller” as used herein refers to hardware that executes software programs.

The storage device 12 includes one or more memory units (computer memories) for storing a program that is executed by the control device 11 and various data that are used by the control device 11. A known storage medium, such as a magnetic storage medium or a semiconductor storage medium, or a combination of a plurality of various types of storage media can be used as the storage device 12. A portable storage medium that is attached to/detached from the audio processing system 100 or a storage medium (for example, cloud storage) that the control device 11 can read from or write to via a communication network such as the Internet can also be used as the storage device 12. The audio signal X can be stored in the storage device 12. In a configuration in which the audio signal X is stored in the storage device 12, the signal supply device 200 can be omitted.

The D/A converter 14 converts the digital audio signal Z into an analog audio signal Az. The sound output device 15 reproduces sound represented by the audio signal Az. For example, a speaker or headphones are used as the sound output device 15. An illustration of an amplifier that amplifies the audio signal Az is omitted for the sake of convenience. The sound output device 15 separate from the audio processing system 100 can be connected to the audio processing system 100 wirelessly or by wire. That is, the sound output device 15 is not essential for the audio processing system 100.

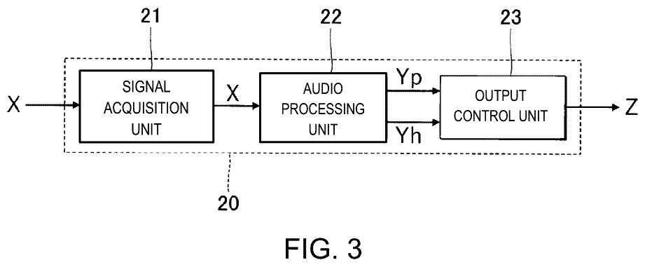

FIG. 3 is a block diagram showing a functional configuration of the audio processing system 100. The control device 11 functions as a signal processing unit 20 for generating the audio signal Z from the audio signal X by executing a program stored in the storage device 12. The signal processing unit 20 comprises a signal acquisition unit 21, an audio processing unit 22, and an output control unit 23. The signal acquisition unit 21 acquires the audio signal X. Specifically, the signal acquisition unit 21 sequentially acquires each sample of the audio signal X output from the A/D converter 13.

The audio processing unit 22 generates an audio signal Yp and an audio signal Yh from the audio signal X. The audio signal Yp (p: percussive) is a signal in which non-percussive components in the audio signal X are suppressed (ideally removed). The audio signal Yp is, in other words, a signal in which the percussive components of the audio signal X are emphasized relative to the non-percussive components. That is, the audio signal Yp is a signal that predominantly contains percussive components of the audio signal X, as compared with non-percussive components.

On the other hand, the audio signal Yh (h: harmonic) is a signal in which the percussive components in the audio signal X are suppressed (ideally removed). The audio signal Yh is, in other words, a signal in which the non-percussive components of the audio signal X are emphasized relative to the percussive components. That is, the audio signal Yh is a signal that predominantly contains non-percussive components of the audio signal X, as compared with percussive components.

As can be understood from the foregoing explanation, the audio processing unit 22 separates the audio signal X into percussive components (audio signal Yp) and non-percussive components (audio signal Yh). The audio signal Yp is one example of a “second audio signal” and the audio signal Yh is one example of a “third audio signal.”

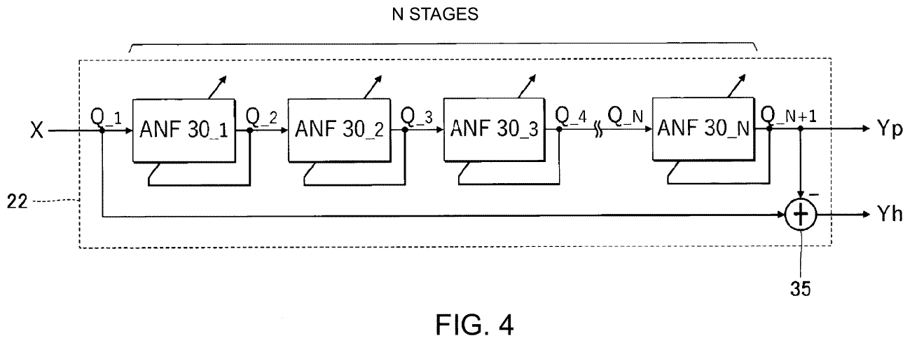

FIG. 4 is a block diagram showing a specific configuration of the audio processing system 22. The audio processing unit 22 comprises a plurality of stages (N stages) of adaptive notch filters (ANF) 30_1 to 30_N, and a signal generation unit 35. The number of stages N of the adaptive notch filters 30_n (n=1 to N) is a natural number of two or more.

The N stages of adaptive notch filters 30_1 to 30_N are connected to each other in series. The audio signal X is supplied to the first stage adaptive notch filter 30_1 as signal Q_1. The adaptive notch filter 30_n of each stage executes the adaptive notch filter processing on a signal Q_n to generate a signal Q_n+1. The n-th stage adaptive notch filter processing is signal processing in which components within a sufficiently narrow stopband of the signal Q_n are selectively suppressed (ideally removed). Components of the signal Q_n outside of the stopband are maintained before and after the adaptive notch filter processing. A signal Q_n+1 after being processed by the adaptive notch filter 30_n of each stage is supplied to the adaptive notch filter 30_n+1 of the subsequent stage. That is, the signal Q_n is an input signal with respect to the adaptive notch filter 30_n, and signal Q_n+1 is an output signal from the adaptive notch filter 30_n. A signal Q_N+1 after being processed by the adaptive notch filter 30_N of the Nth stage (that is, the final stage) is output from the audio processing unit 22 as the audio signal Yp. As can be understood from the foregoing explanation, the audio processing unit 22 serially executes N stages of adaptive notch filter processing on the audio signal X to generate the audio signal Yp.

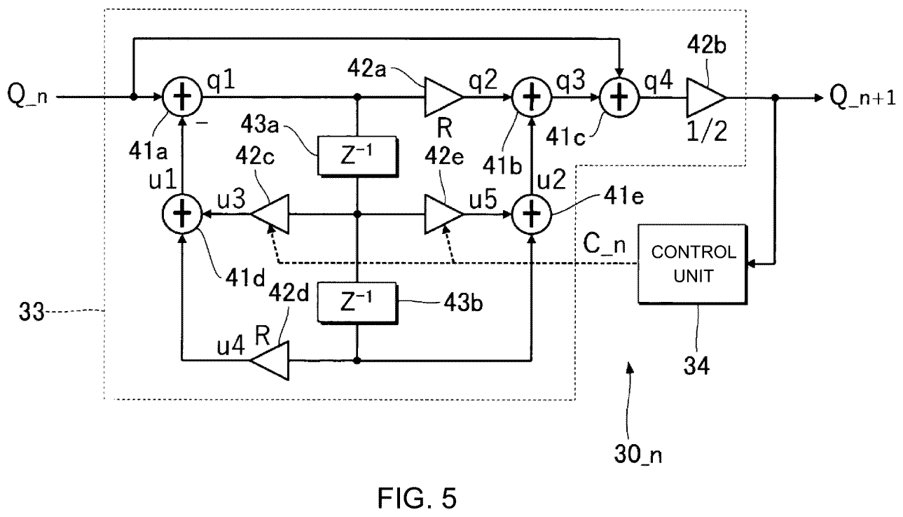

FIG. 5 is a block diagram showing a configuration of each adaptive notch filter 30_n. The adaptive notch filter 30_n comprises a filter unit 33 and a control unit 34. The filter unit 33 is a notch filter that suppresses components of the signal Q_n within the stopband to generate the signal Q_n+1.

Specifically, the filter unit 33 is a recursive filter including a plurality of addition units 41 (41a, 41b, 41c, 41d, 41c), a plurality of multiplication units 42 (42a, 42b, 42c, 42d, 42c), and a plurality of delay units 43 (43a, 43b). The addition unit 41a subtracts a signal u1, described further below, from the signal Q_n to generate a signal q1. The multiplication unit 42a multiplies the signal q1 by a coefficient R to generate a signal q2. The addition unit 41b adds a signal u2, described further below, to the signal q2 to generate a signal q3. The addition unit 41c adds a signal Q_n to the signal q3 to generate a signal q4. The multiplication unit 42b multiplies the signal q4 by a constant (for example, 1/2) to generate a signal Q_n+1.

Each of the delay units 43a and 43b delays the signal q1 by one sampling period. The multiplication unit 42a multiplies the signal q1 that has been processed by the delay unit 43a by a coefficient C_n to generate a signal u3. The multiplication unit 42b multiplies the signal q1 that has been processed by the delay unit 43b by the coefficient R to generate a signal u4. The addition unit 4d adds the signal u3 and the signal u4 to generate the above-mentioned signal u1. The multiplication unit 42e multiplies the signal q1 that has been processed by the delay unit 43a by a coefficient C_n to generate a signal u5. The addition unit 41e adds the signal u5 and the signal q1 that has been processed by the delay unit 43b to generate the above-mentioned signal u2.

The coefficient R is a coefficient for controlling the bandwidth of the stopband, and is set to a prescribed positive number, for example. The coefficient C_n is a coefficient for controlling the frequency of the stopband (hereinafter referred to as “stop frequency”) ω_n. The stop frequency ω_n is the center frequency of the stopband, for example. The stop frequency ω_n, the coefficient R, and the coefficient C_n satisfy the relationship of the following equation (1).

$$C\_n = - ( 1 + R ) cos ( ω\_n ) \qquad ( 1 )$$

The control unit 34 controls the coefficient C_n described above. Specifically, the control unit 34 controls the coefficient C_n in accordance with the signal Q_n+1 output from the filter unit 33. For example, the control unit 34 adaptively controls the coefficient C_n such that the signal strength (energy) of the signal Q_n+1 is minimized. That is, the stop frequency ω_n changes over time from an initial value in accordance with the signal strength of the signal Q_n+1 such that the signal strength of the signal Q_n+1 is reduced. The initial value of each stop frequency ω_n is set to a common value (for example, 2 kHz) across the N stop frequencies ω_1 to ω_N. However, the initial value can be different for every stop frequency ω_n.

For example, the control unit 34 iteratively updates the coefficient C_n so as to minimize the above-mentioned signal q4(t), which corresponds to the error. The symbol t is the sample number on the time axis. An adaptive algorithm, such as Normalized Least Mean Square (NLMS) is used to update the coefficient C_n. Specifically, the control unit 34 updates the coefficient C_n in accordance with a slope A defined by the following equation regarding the loss function {q4(t)}<sup>2</sup>. Symbol E{ } stands for expected value.

$$Δ = E \{ q 4 ( t ) 〈 sup 〉 2 〈 / sup 〉 \} / E \{ q 1 ( t ) 〈 sup 〉 2 〈 sup 〉 \}$$

If the coefficient C_n is updated using, instead of the slope A illustrated above, a slope that increases monotonically in accordance with the difference from an unknown harmonic frequency, the time until convergence of the coefficient C_n can be shortened. That is, the speed at which the stop frequency ω_n of the filter unit 33 approaches one of the frequencies of the plurality of non-percussive components increases. The adaptive algorithm described above is discloses in, for example, Yosuke Sugiura et al., “Monotonically Increasing Function,” NOLTA2014, Luzern, Switzerland, Sep. 14-18, 2014.

As described above, the non-percussive components are acoustic components in which the signal strength in the frequency domain is locally high compared to its surroundings. That is, the signal strength decreases significantly as a result of the non-percussive components being suppressed. Accordingly, the control unit 34 controls the coefficient C_n such that the stop frequency ω_n approaches (ideally matches) the frequency of the non-percussive components contained in the signal Q_n. Specifically, by repeatedly updating the coefficient C_n using the method described above, the stop frequency ω_n approaches one of the frequencies of the plurality of non-percussive components contained in the signal Q_n, resulting in a gradual decrease in the signal strength of the signal Q_n+1. That is, in the n-th stage adaptive notch filter processing, the stop frequency ω_n is controlled in accordance with the signal Q_n+1 such that the stop frequency ω_n approaches the frequency of the non-percussive components contained in the signal Q_n to be processed. As described above, the stop frequency ω_n (or coefficient C_n) is individually set for each adaptive notch filter 30_n.

As described above with reference to FIG. 2, the non-percussive components of the audio signal X include a plurality of harmonic components. The control unit 34 of each adaptive notch filter 30_n controls the stop frequency ω_n so that it approaches a frequency corresponding to any one of a the plurality of harmonic components of the audio signal X. The filter unit 33 of each adaptive notch filter 30_n suppresses any one of the plurality of harmonic components contained in the signal Q_n. Accordingly, the signal Q_n+1 that is output by the adaptive notch filter 30_n is a signal in which n harmonic components out of the plurality of harmonic components contained in the audio signal X are suppressed. That is, the plurality of harmonic components contained in the audio signal X are cumulatively suppressed, one by one, for each adaptive notch filter processing, so that a total of N harmonic components are suppressed as a result of N stages of adaptive notch filter processing. As can be understood from the description above, the audio signal Yp (signal Q_N+1) that is output by the Nth stage adaptive notch filter 30_N is a signal in which the non-percussive components of the audio signal X are suppressed.

The signal generation unit 35 of FIG. 4 uses the audio signal X and the audio signal Yp to generate the audio signal Yh. Specifically, the signal generation unit 35 subtracts the audio signal Yp from the audio signal X to generate the audio signal Yh. As described above, the audio signal X includes percussive components and non-percussive components, and the audio signal Yp is a signal in which the percussive components are emphasized. Accordingly, the audio signal Yh that is generated by the signal generation unit 35 is a signal that predominantly contains non-percussive components of the audio signal X, as described above. As described above, in the first embodiment, non-percussive components (audio signal Yh) of the audio signal X can be generated by a simple process of subtracting the audio signal Yp from the audio signal X.

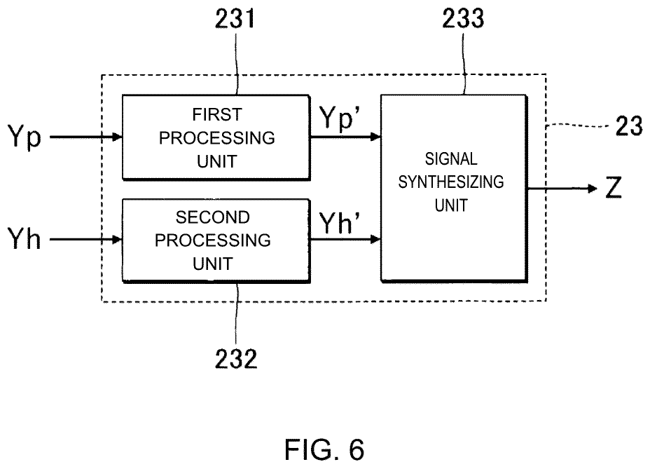

The output control unit 23 of FIG. 3 uses the audio signal Yp and the audio signal Yh to generate the audio signal Z. FIG. 6 is a block diagram showing a configuration of the output control unit 23. The output processing unit 23 comprises a first processing unit 231, a second processing unit 232, and a signal synthesizing unit 233.

The first processing unit 231 executes a first process on the audio signal Yp to generate an audio signal Yp′. The first process is signal processing that changes the acoustic characteristics (such as a frequency characteristic) of the audio signal Yp. On the other hand, the second processing unit 232 executes a second process on the audio signal Yh to generate an audio signal Yh′. The second process is signal processing that changes the acoustic characteristics (such as a frequency characteristic) of the audio signal Yh. The first process and the second process are, for example, amplification processes for amplifying signals, or effect imparting processes for imparting various frequency characteristics to signals.

The conditions for the first process and the second process are different. For example, the gain that is applied to the amplification process is different between the first process and the second process. Additionally, the frequency characteristic that is imparted to the signal is different between the first process and the second process. The first process and the second process can be different types of signal processing. For example, one of the amplification process and the effect imparting process can be executed as the first process, while the other is executed as the second process.

The signal synthesizing unit 233 synthesizes the audio signal Yp′ after the first process and the audio signal Yh′ after the second process to generate the audio signal Z. For example, the signal synthesizing unit 233 uses the weighted sum of the audio signal Yp′ and the audio signal Yh′ to generate the audio signal Z.

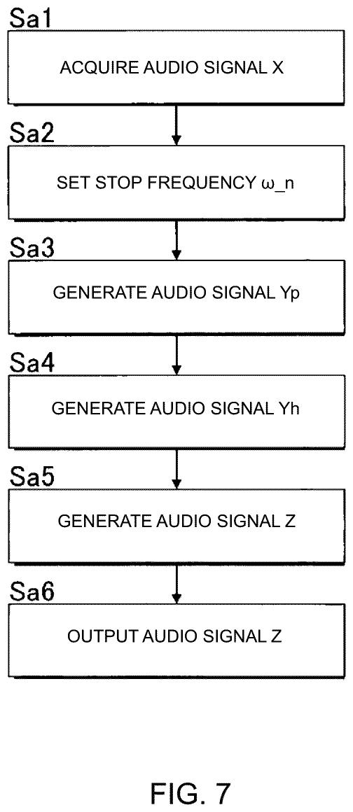

FIG. 7 is a flowchart of the process that is executed by the control device 11. For example, the process of FIG. 7 is executed for each sample of the audio signal X. That is, the process is executed for each sampling period of the audio signal X, for example.

The control device 11 (signal acquisition unit 21) acquires the audio signal X (Sa1). Specifically, the control device 11 acquires a sample of the audio signal X output from the A/D converter 13. The control device 11 (control unit 34) controls each coefficient C_n (C_1 to C_N) to set the stop frequency ω_n in each adaptive notch filter processing (Sa2). The control device 11 (audio processing unit 22) serially executes N stages of adaptive notch filter processing on the audio signal X to generate the audio signal Yp (Sa3). In addition, the control device 11 (audio processing unit 22) subtracts the audio signal Yp from the audio signal X to generate the audio signal Yh (Sa4). The control device 11 (output control unit 23) generates the audio signal Z from the audio signal Yp and the audio signal Yh (Sa5). The control device 11 (output control unit 23) outputs the audio signal Z to the sound output device 15 (Sa6).

As described above, in the first embodiment, by serially executing N stages of adaptive notch filter processing, it becomes possible to generate the audio signal Yp in which the non-percussive components of the audio signal X are sequentially suppressed. Accordingly, it is possible to use the anisotropism between continuousness in the time axis direction and continuousness in the frequency axis direction to reduce the processing delay, as compared with the technique of Ono et al., “Harmonic and Percussive Sound Separation and its Application to MIR-related Tasks,” Springer 274, pp. 213-236, 2010. in which percussive components of the audio signal are emphasized or suppressed. In addition, in the adaptive notch filter processing of each stage, the stop frequency ω_n is adaptively controlled so as to approach the frequency of the non-percussive components in the signal Q_n. That is, it is not necessary to estimate the fundamental frequency F0 of the audio signal X in order to set the stop frequency ω_n. Therefore, compared to the technique of Japanese Laid-Open Patent Application No. 2003-122368, it is possible to suppress the non-percussive components of the audio signal X with high accuracy, without being affected by the estimation error of the fundamental frequency F0. That is, according to the first embodiment, it is possible to separate the acoustic components (percussive components or non-percussive components) of the audio signal X with high accuracy, while reducing the processing delay. In the first embodiment, any of the plurality of harmonic components contained in the audio signal X is reduced by each adaptive notch filter processing. Accordingly, it is possible to generate the audio signal Yp in which a plurality of harmonic components are suppressed.

In a configuration in which one fundamental frequency is estimated by the analysis of an audio signal, such as that of Japanese Laid-Open Patent Application No. 2003-122368, it is difficult to process, with high accuracy, an audio signal that includes a plurality of acoustic components having different fundamental frequencies. In contrast to the technique of Japanese Laid-Open Patent Application No. 2003-122368, estimation of the fundamental frequency is not a prerequisite in the first embodiment; rather, the stop frequency ω_n is controlled so as to approach the frequency of the non-percussive components in the signal Q_n. Therefore, it is possible to also process an audio signal that includes a plurality of acoustic components with different fundamental frequencies (i.e., a multi-pitch signal).

### B: Second Embodiment

The second embodiment will be described. In each of the embodiments illustrated below, elements that have the same functions as those in the first embodiment have been assigned the same reference symbols used to describe the first embodiment and detailed descriptions thereof have been appropriately omitted.

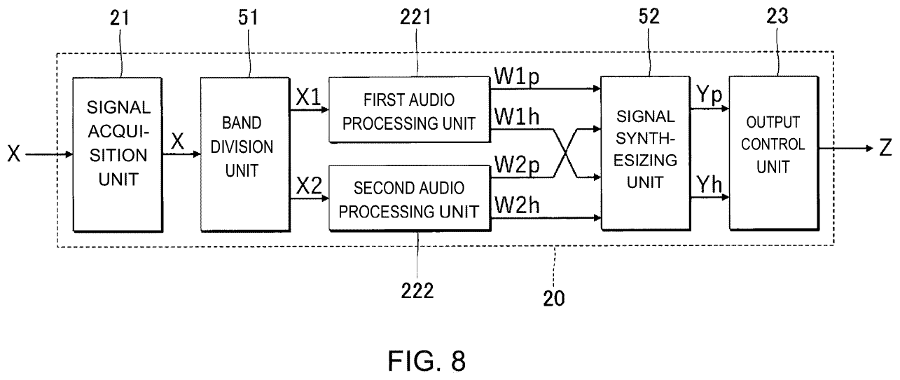

FIG. 8 is a block diagram showing the functional configuration of the audio processing system 100 according to a second embodiment. The control device 11 of the second embodiment functions as the signal processing unit 20 for generating the audio signal Z from the audio signal X, in the same manner as in the first embodiment. The signal processing unit 20 of the second embodiment comprises the signal acquisition unit 21, a band division unit 51, a first audio processing unit 221, a second audio processing unit 222, a signal synthesizing unit 52, and the output control unit 23. The signal acquisition unit 21 acquires the audio signal X, in the same manner as in the first embodiment.

The band division unit 51 generates a band signal X1 and a band signal X2 from the audio signal X. The band signal X1 is a component of the audio signal X within a first frequency band B1. On the other hand, the band signal X2 is a component of the audio signal X within a second frequency band B2. The band division unit 51 includes a filter that allows components of the audio signal X within the first frequency band B1 to pass through as the band signal X1, and a filter that allows components within the second frequency band B2 to pass through as the band signal X2. The band signal X1 is one example of a “first band signal,” and the band signal X2 is one example of a “second band signal.”

As shown in FIG. 2, the first frequency band B1 and the second frequency band B2 are different frequency bands. Specifically, the first frequency band B1 is a frequency band that is on the lower side of the second frequency band B2. For example, the upper limit of the first frequency band B1 matches the lower limit of the second frequency band B2. It is also possible to conceive of a configuration in which the first frequency band B1 and the second frequency band B2 are adjacent to each other on the frequency axis with a gap therebetween. In addition, it is also possible to conceive of a configuration in which a part of the first frequency band B1 on the high-frequency side and a part of the second frequency band B2 on the low-frequency side overlap with each other.

The first audio processing unit 221 of FIG. 8 generates a band signal W1p and a band signal W1h from the band signal X1. The band signal W1p is a signal in which the percussive components of the band signal X1 are emphasized, and the band signal W1h is a signal in which the non-percussive components of the band signal X1 are emphasized. The second audio processing unit 222 generates a band signal W2p and a band signal W2h from the band signal X2. The band signal W2p is a signal in which the percussive components of the band signal X2 are emphasized, and the band signal W2h is a signal in which the non-percussive components of the band signal X2 are emphasized. The first audio processing unit 221 and the second audio processing unit 222 operate in parallel with each other. The band signal W1p is one example of a “third band signal,” and the band signal W2p is one example of a “fourth band signal.”

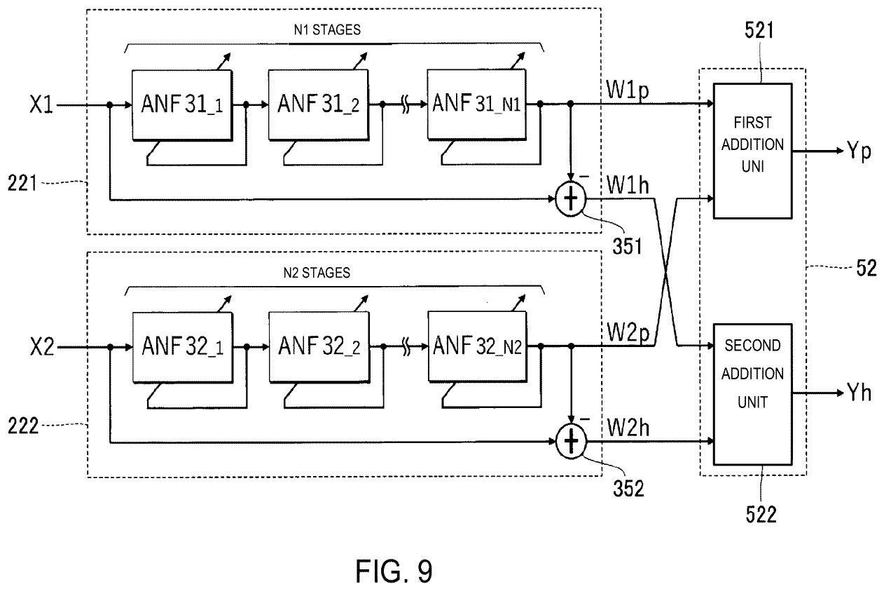

FIG. 9 is a block diagram showing detailed configurations of the first audio processing unit 221, the second audio processing unit 222, and the signal synthesizing unit 52. The first audio processing unit 221 comprises a plurality of stages (N1 stages) of adaptive notch filters 31_1 to 31_N1, and a signal generation unit 351. The N1 stages of adaptive notch filters 30_1 to 30_N1 are connected to each other in series. The band signal X1 is supplied to the first-stage adaptive notch filter 31_1, and the band signal W1p is output from the N1-th-stage (final stage) adaptive notch filter 31_N1. Each adaptive notch filter 31_n1 (n1=1 to N1) selectively suppresses (ideally removes) components of the signal Q_n within the stopband, in the same manner as the adaptive notch filter 30_n of the first embodiment.

A stop frequency ω_n1 of each adaptive notch filter 31_n1 is controlled so as to approach (ideally match) the frequency of the non-percussive components within a signal Q_n1. Specifically, the control unit 34 of each adaptive notch filter 31_n1 controls the stop frequency ω_n1 within the first frequency band B1. As can be understood from the foregoing explanation, the first audio processing unit 221 serially executes N1 stages of the adaptive notch filter processing on the band signal X1 to generate the band signal W1p. The processing of each adaptive notch filter 31_n1 is one example of a “first adaptive notch filter processing.”

The signal generation unit 351 subtracts the band signal W1p from the band signal X1 to generate the band signal W1h. As can be understood from the foregoing explanation, the band signal W1p is a signal in which the percussive components of the audio signal X within the first frequency band B1 are emphasized, and the band signal W1h is a signal in which the non-percussive components of the audio signal X within the first frequency band B1 are emphasized.

The second audio processing unit 222 comprises a plurality of stages (N2 stages) of adaptive notch filters 32_1 to 32_N2, and a signal generation unit 352. The N2 stages of adaptive notch filters 32_1 to 32_N2 are connected to each other in series. The band signal X2 is supplied to the first-stage adaptive notch filter 32_1, and the band signal W2p is output from the N2-th-stage (final stage) adaptive notch filter 32_N2. Each adaptive notch filter 32_n2 (n2=1 to N2) selectively suppresses (ideally removes) components of the signal Q_n within the stopband, in the same manner as the adaptive notch filter 30_n of the first embodiment.

A stop frequency ω_n2 of each adaptive notch filter 32_n2 is controlled so as to approach (ideally match) the frequency of the non-percussive components within a signal Q_n2. Specifically, the control unit 34 of each adaptive notch filter 32_n2 controls the stop frequency ω_n2 within the second frequency band B2. As can be understood from the foregoing explanation, the second audio processing unit 222 serially executes N2 stages of the adaptive notch filter processing on the band signal X2 to generate the band signal W2p. The processing of each adaptive notch filter 32_n2 is one example of a “second adaptive notch filter processing.”

A signal generation unit 352 subtracts the band signal W2p from the band signal X2 to generate the band signal W2h. As can be understood from the foregoing explanation, the band signal W2p is a signal in which the percussive components of the audio signal X within the second frequency band B2 are emphasized, and the band signal W2h is a signal in which the non-percussive components of the audio signal X within the second frequency band B2 are emphasized.

In human auditory properties, there is a tendency that acoustic components on the higher frequency side tend to be more easily attenuated over time. That is, the non-percussive components contained in the high-frequency side of the band signal X2 attenuates more easily than the non-percussive components contained in the low-frequency side of the band signal X1. In consideration of the tendency described above, the number of stages N1 of the adaptive notch filters 31_1 to 31_N1 is greater than the number of stages N2 of the adaptive notch filters 32_1 to 32_N2 (N1>N2). That is, the number N1 of non-percussive components that are in the band signal X1 on the low-frequency side and that are suppressed by the first audio processing unit 221, is greater than the number N2 of the non-percussive components in the band signal X2 on the high-frequency side and that are suppressed by the second audio processing unit 222.

Accordingly, it is possible to reduce the number of stages N2 of the adaptive notch filter 32_n2 used for suppressing the non-percussive components on the high-frequency side, which attenuate easily, while sufficiently suppressing the non-percussive components on the low-frequency side, which do not attenuate easily, using the N1 stages of adaptive notch filters 31_1 to 31_N1. That is, the non-percussive components on the low-frequency side can be sufficiently suppressed while reducing the overall number of stages of the adaptive notch filter processing. However, a configuration in which the number of stages N1 and the number of stages N2 are the same is also conceivable.

The signal synthesizing unit 52 of FIG. 8 uses the output signals (W1p, W1h) from the first audio processing unit 221 and the output signals (W2p, W2h) from the second audio processing unit 222 to generate the audio signals Yp and Yh. As shown in FIG. 9, the signal synthesizing unit 52 comprises a first addition unit 521 and a second addition unit 522.

The first addition unit 521 adds the band signal W1p and the band signal W2p to generate the audio signal Yp. Therefore, the audio signal Yp is a signal spanning the first frequency band B1 and the second frequency band B2, and is a signal in which the percussive components of the audio signal X are emphasized, in the same manner as in the first embodiment. The first addition unit 521 can use the weighted sum of the band signal W1p and the band signal W2p to generate the audio signal Yp.

The second addition unit 522 adds the band signal W1h and the band signal W2h to generate the audio signal Yh. Therefore, the audio signal Yh is a signal spanning the first frequency band B1 and the second frequency band B2, and is a signal in which the non-percussive components of the audio signal X are emphasized, in the same manner as in the first embodiment. The second addition unit 522 can use the weighted sum of the band signal W1h and the band signal W2h to generate the audio signal Yh.

The configuration and operation of the output control unit 23 of FIG. 8 are the same as those in the first embodiment. That is, the output control unit 23 uses the audio signal Yp and the audio signal Yh to generate the audio signal Z.

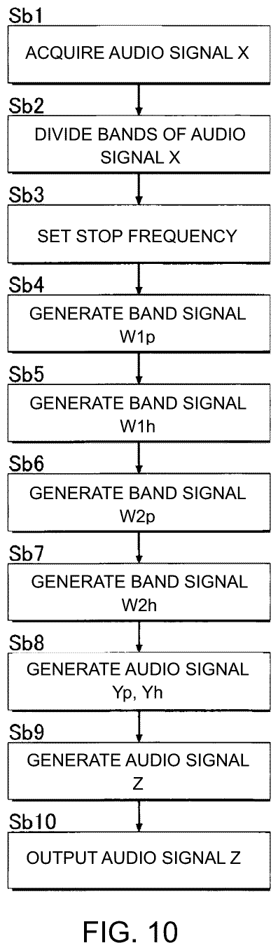

FIG. 10 is a flowchart of the process that is executed by the control device 11. For example, the process of FIG. 10 is executed for each sample of the audio signal X. That is, the process is executed for each sampling period of the audio signal X, for example.

The control device 11 (signal acquisition unit 21) acquires the audio signal X (Sb1). The control device 11 (band division unit 51) divides the audio signal X into the band signal X1 and the band signal X2 (Sb2). The control device 11 (control unit 34) sets the stop frequency ω_n1 of each adaptive notch filter 31_n1, and the stop frequency ω_n2 of each adaptive notch filter 32_n2 (Sb3). The control device 11 (first audio processing unit 221) serially executes N1 stages of adaptive notch filter processing on the band signal X1 to generate the band signal W1p (Sb4). The control device 11 subtracts the band signal W1p from the band signal X1 to generate the band signal W1h (Sb5). In addition, the control device 11 (second audio processing unit 222) serially executes N2 stages of adaptive notch filter processing on the band signal X2 to generate the band signal W2p (Sb6). The control device 11 subtracts the band signal W2p from the band signal X2 to generate the band signal W2h (Sb7). The control device 11 (signal synthesizing unit 52) synthesizes the band signal W1p and the band signal W2p to generate the audio signal Yp, and synthesizes the band signal W1h and the band signal W2h to generate the audio signal Yh (Sb8). The control device 11 (output control unit 23) generates the audio signal Z from the audio signal Yp and the audio signal Yh (Sb9), and outputs the audio signal Z to the sound output device 15 (Sb10).

The same effects as those of the first embodiment are realized in the second embodiment. In addition, in the second embodiment, the stop frequency ω_n1 of each adaptive notch filter 31_n1 is controlled within the first frequency band B1, and the stop frequency ω_n2 of each adaptive notch filter 32_n2 is controlled within the second frequency band B2. That is, compared to a configuration in which the audio signal X is not divided into a plurality of frequency bands, the range in which the stop frequency ω_n1 and the stop frequency ω_n2 are changed is limited. Therefore, the stopband can be efficiently controlled.

### C: Modified Examples

Specific modified embodiments to be added to each of the embodiments exemplified above are illustrated below. A plurality of embodiments selected freely from the aforementioned embodiments and the following modified examples can be appropriately combined as long as they are not mutually contradictory.

In the following description, attention will be focused on the N stages of adaptive notch filters 30_1 to 30_N of the first embodiment, for the sake of convenience. A configuration that is applied to each adaptive notch filter 30_n is also applied to the adaptive notch filter 31_n1 and the adaptive notch filter 32_n2 of the second embodiment. In addition, the configuration shown below regarding the audio processing unit 22 of the first embodiment is similarly applied to the first audio processing unit 221 and the second audio processing unit 222 of the second embodiment.

(1) The stop frequency ω_n of each adaptive notch filters 30_1 to 30_N can be controlled under various constraints. For example, each control unit 34 can control the stop frequency ω_n such that the stop frequencies ω_n of the N stages of adaptive notch filters 30_1 to 30_N would have integer multiples relationships, from the low-frequency side to the high-frequency side. For example, when the control unit 34 of the first-stage adaptive notch filter 30_1 sets the stop frequency ω_1, the control unit 34 of each adaptive notch filter 30_n of the second and subsequent stages controls the stop frequency ω_n using the value of an integer multiple (×M) or an inverse integer multiple (×1/M) of said stop frequency ω_1 as the initial value. That is, a plurality of the stop frequencies ω_n are arranged at equal intervals on the frequency axis. According to the configuration described above, it is possible to suppress the plurality of harmonic components contained in the audio signal X quickly and with high accuracy, as compared with a configuration in which the stop frequency ω_n can span the entire band. The configuration described above is particularly effective when the non-percussive components of the audio signal X are expected to have a harmonic structure.

(2) In each of the embodiments described above, harmonic components are shown as examples of non-percussive components, but the non-percussive components are not limited to harmonic components. For example, if attention is paid to the process from the start of production of a musical sound to its attenuation over time, the attack portion immediately after the start of sound production corresponds to the percussive component, and the sustain portion in which the volume is steadily maintained corresponds to the non-percussive component. Accordingly, the audio processing unit 22 also functions as an element that generates the audio signal Yp in which the attack portion included in the audio signal X is emphasized, and the audio signal Yh in which the sustain portion included in the audio signal X is emphasized.

(3) The first process that the first processing unit 231 executed on the audio signal Yp and the second process that the second processing unit 232 executed on the audio signal Yh are not limited to the above-mentioned amplification process and effect imparting process. For example, a sound image localization process for localizing a sound image perceived by a listener to a specific location can be individually executed on each of the audio signal Yp and the audio signal Yh as the first and second processes. According to the configuration described above, by individually setting conditions of the sound image localization process for each of the percussive components and the non-percussive components, it is possible to construct a sound field in which the listener can perceive a pronounced three-dimensional effect or sense of presence. In addition, a first process in which the audio signal Yp is replaced with another audio signal, or a second process in which the audio signal Yh is replaced with another audio signal, can be executed. An audio signal that replaces the audio signal Yp or the audio signal Yh is an audio signal that is recorded or synthesized in advance. As described above, by separating the audio signal X into the audio signal Yp and the audio signal Yh, a wide variety of audio processing can be achieved.

(4) In each of the embodiments described above, an example has been shown in which the audio processing unit 22 generates both the audio signal Yp and the audio signal Yh, but it is also possible to conceive of a configuration in which the audio processing unit 22 generates only one of the audio signal Yp or the audio signal Yh. For example, the audio processing unit 22 can output only the audio signal Yp that is generated by the N stages of adaptive notch filters 30_1 to 30_N. That is, the signal generation unit 35 can be omitted. In addition, the audio processing unit 22 can output only the audio signal Yh generated by the signal generation unit 35. That is, the output of the audio signal Yp can be omitted.

In a configuration in which the audio processing unit 22 generates only one of the audio signal Yp and the audio signal Yh, the process of the output control unit 23 synthesizing the audio signal Yp and the audio signal Yh is omitted. For example, the output control unit 23 executes a process, such as an amplification process or an effect imparting process, on the audio signal Yp or the audio signal Yh. The audio signal Yp or the audio signal Yh generated by the audio processing unit 22 can be output to the D/A converter 14. That is, the output control unit 23 can be omitted. In addition, in the second embodiment, either the first addition unit 521 or the second addition unit 522 can be omitted.

(5) In each of the embodiments described above, an example was presented in which the audio signal Z is supplied to the sound output device 15, but the destination of the supply of the audio signal Z is not limited to the sound output device 15. For example, the audio signal Z can be transmitted to another communication device via a communication network, such as the Internet. In addition, the audio signal Z can be stored in the storage device 12.

(6) The audio processing system 100 can also be realized by a server device that communicates with a terminal device such as a mobile phone or a smartphone. For example, the audio processing system 100 processes the audio signal X received from a terminal device to generate the audio signal Z, and transmits the audio signal Z to the terminal device. The audio signal Yp or the audio signal Yh generated by the audio processing system 100 can be transmitted to the terminal device.

(7) In the second embodiment, the audio signal X is divided into the band signal X1 of the first frequency band B1 and the band signal X2 of the second frequency band B2, but the audio signal X can be divided into three or more bands. The audio processing unit 22 including the multi-stage adaptive notch filter 30 is provided for each frequency band after division of the audio signal X. The number of stages of the adaptive notch filter 30 can be individually set for each frequency band, or be set to a common numerical value across all frequency bands.

(8) As described above, the functions of the audio processing system 100 according to the embodiments described above are realized by the collaborative interactions between one or more processors that constitute the control device 11 and a program stored in the storage device 12. The program exemplified above can be stored on a computer-readable storage medium and installed in a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. In addition, in a configuration in which a distribution device distributes the program via a communication network, a storage medium that stores the program in the distribution device corresponds to the non-transitory storage medium.

### D: Addendum

For example, the following configurations can be understood from the embodiments exemplified above.

An audio processing method according to one aspect (Aspect 1) of the present disclosure comprises: acquiring a first audio signal including percussive components and non-percussive components, and serially executing a multistage adaptive notch filter processing on the first audio signal to generate a second audio signal in which the non-percussive components in the first audio signal are suppressed.

According to the aspect described above, it is possible to serially execute a multistage adaptive notch filter processing to generate a second audio signal in which the non-percussive components of the first audio signal are sequentially suppressed. That is, a second audio signal that predominantly contains percussive components of the first audio signal is generated. Accordingly, it is possible to use the anisotropism between continuousness in the time axis direction and continuousness in the frequency axis direction to reduce the processing delay, as compared with a configuration in which percussive components or non-percussive components of the audio signal are emphasized or suppressed. In addition, in the adaptive notch filter processing of each stage, the frequency of the stopband is adaptively controlled so as to approach the frequency of the non-percussive components in the input signal. That is, it is not necessary to estimate the fundamental frequency of the first audio signal in order to set the frequency of the stopband. Therefore, the non-percussive components of the first audio signal can be suppressed with high accuracy, without being affected by the estimation error of the fundamental frequency. As described above, according to one aspect of the present disclosure, acoustic components of the first audio signal can be separated with high accuracy while reducing processing delay.

“Percussive components” are non-peak components that are distributed across a wide range of the frequency domain. For example, a performance sound of a percussion instrument is an example of a percussive component. In addition, noise components (such as white noise) that are distributed across a wide range of the frequency domain also fall under the category of “percussive components.” Percussive components tend to decay in a shorter time as compared with non-percussive components.

“Non-percussive components” are peak components in which the signal strength (energy) in the frequency domain is locally high compared to its surroundings. For example, harmonic components containing fundamental components and overtone components are an example of “non-percussive components.” Non-percussive components tend to decay over a longer period as compared with percussive components.

Focusing on the continuousness of acoustic components, “percussive components (non-peak components” are acoustic components that tend to be continuous in the frequency axis direction (frequency spectrum), and “non-percussive components (peak components)” are acoustic components that tend to be continuous in the time axis direction (time waveform).

Focusing on the process from the start of production of a musical instrument sound or a singing sound to its attenuation over time, non-harmonic components tend to be predominant in the attack portion, and harmonic components tend to be predominant in the sustain portion. In consideration of the tendencies described above, the attack portion of a signal corresponds to the “percussive components (non-peak components)” and the sustain portion corresponds to the “non-percussive components (peak components).” The attack portion is a section immediately after the start of production of sound. The sustain portion is a section that follows the attack portion and in which the acoustic characteristics are stably maintained.

As described above, non-percussive components change more gradually over time than percussive components. However, non-percussive components are acoustic components contained in musical sounds or voice, so the speed of rise and fall of the acoustic components thereof are much higher than those of acoustic components of audio feedback, for example. For example, a time constant relating to temporal variation of non-percussive components is shorter than that of acoustic components of audio feedback by several orders of magnitude.

“Adaptive notch filter processing” is signal processing for generating an output signal by suppression of acoustic components of an input signal in the stopband. In adaptive notch filter processing, the frequency of the stopband is adaptively controlled in accordance with the output signal so that the frequency of the stopband approaches the frequency of the non-percussive components in the input signal.

“Serially execute a multistage adaptive notch filter processing” means that a first audio signal is processed by first-stage adaptive notch filter processing, and the output signal of the immediately preceding adaptive notch filter processing is processed as the input signal of each adaptive notch filter processing of the second and subsequent stages. That is, the non-percussive components of the first audio signal is cumulatively suppressed by the multiple stages of adaptive notch filter processing.

In a specific example (Aspect 2) of Aspect 1, in each of the plurality of stages of adaptive notch filter processing, frequency of a stopband is controlled in accordance with an output signal of the adaptive notch filter processing such that the frequency of the stopband approaches the frequency of non-percussive components in an input signal that is processed by the adaptive notch filter processing.

“Control the frequency of the stopband” refers to a process of controlling a coefficient that is applied to an adaptive notch filter processing such that the signal strength of the output signal of the adaptive notch filter processing is decreased (ideally minimized), for example.

In a specific example (Aspect 3) of Aspect 2, the non-harmonic components contain a plurality of harmonic components, and, in controlling the frequency of the stopband, the frequency of the stopband is controlled so as to approach a frequency corresponding to any of the plurality of harmonic components, for each of the plurality of stages of adaptive notch filter processing. According to the aspect described above, any of the plurality of harmonic components contained in the first audio signal is suppressed by each adaptive notch filter processing. Accordingly, it is possible to generate a second audio signal in which a plurality of harmonic components are suppressed. That is, the second audio signal is a signal that predominantly contains the non-harmonic components of the first audio signal

The “plurality of harmonic components” are acoustic components that contain a fundamental component and one or more overtone components. A fundamental component is an acoustic component of a fundamental frequency, and an overtone component is an acoustic component of an overtone frequency that is an integer multiple of the fundamental frequency.

In a specific example (Aspect 4) of Aspect 3, in controlling the frequency of the stopband, frequency of a stopband in each adaptive notch filter processing is controlled such that the frequencies of the plurality of stopbands in each of the plurality of stages of adaptive notch filter processing are arranged on a frequency axis at equal intervals. According to the aspect described above, the frequency of the stopband in each adaptive notch filter processing is controlled under the constraint that the frequencies of the stopbands in each of the adaptive notch filter processing are integer multiples. Accordingly, a plurality of harmonic components contained in the first audio signal can be suppressed quickly and with high accuracy, as compared with a configuration in which the stop band frequency can span the entire band.

In a specific example (Aspect 5) of any one of Aspects 1 to 4, the second audio signal is subtracted from the first audio signal to generate a third audio signal. According to the aspect described above, the second audio signal is subtracted from the first audio signal to generate the third audio signal. As described above, the second audio signal predominantly contains the percussive component of the first audio signal, so the third audio signal is a signal that predominantly contains the non-percussive components of the first audio signal. That is, the first audio signal can be separated into non-percussive components (third audio signal) and percussive components (second audio signal) by a simple calculation of subtracting the second audio signal from the first audio signal.

An audio processing method according to another aspect (Aspect 6) of the present disclosure comprises: generating, from a first audio signal containing percussive components and non-percussive components, a first band signal in a first frequency band, and a second band signal in a second frequency band that is different from the first frequency band, serially executing a multistage first adaptive notch filter processing on the first band signal to generate a third band signal in which the non-percussive components in the first band signal are suppressed, serially executing a multistage second adaptive notch filter processing on the second band signal to generate a fourth band signal in which the non-percussive components in the second band signal are suppressed, and synthesizing the third band signal and the fourth band signal to generate a second audio signal.

In the aspect described above, the frequency of the stopband is controlled within the first frequency band for each of the first adaptive notch filter processing, and the frequency of the stopband is controlled within the second frequency band for each of the second adaptive notch filter processing. That is, the range in which the frequency of the stop of each adaptive notch filter processing is changed is limited, as compared with a configuration in which the first audio signal is not divided into a plurality of frequency bands. Therefore, it is possible to efficiently control the stopband in each adaptive notch filter processing. The first frequency band and the second frequency band are two of a plurality of frequency bands. The number of divisions of the first audio signal (total number of frequency bands) is any number of two or more.

In a specific example (Aspect 7) of Aspect 6, the first frequency band is a frequency band on a lower frequency side than the second frequency band, and the number of stages of the first adaptive notch filter processing is greater than the number of stages of the second adaptive notch filter processing. In human auditory properties, there is a tendency that acoustic components on the higher frequency side tend to be more easily attenuated over time. Therefore, if the number of stages of the first adaptive notch filter processing is greater than the number of stages of the second adaptive notch filter processing, such as in the above-mentioned embodiment, the non-percussive components on the low-frequency side can be sufficiently suppressed while reducing the overall number of stages of the adaptive notch filter processing.

An audio processing system according to one aspect (Aspect 8) of the present disclosure comprises, a signal acquisition unit for acquiring a first audio signal including percussive components and non-percussive components, and an audio processing unit for serially executing a multistage adaptive notch filter processing on the first audio signal to generate a second audio signal in which the non-percussive components in the first audio signal are suppressed.

A program according to one aspect (Aspect 9) of the present disclosure causes a computer system to function as a signal acquisition unit for acquiring a first audio signal including percussive components and non-percussive components; and an audio processing unit for serially executing a multistage adaptive notch filter processing on the first audio signal to generate a second audio signal in which the non-percussive components in the first audio signal are suppressed.

What is claimed is:

1. An audio processing method realized by a computer system, the audio processing method comprising:
acquiring a first audio signal including percussive components and non-percussive components; and
serially executing a plurality of stages of adaptive notch filter processing on the first audio signal, thereby generating a second audio signal in which the non-percussive components in the first audio signal are suppressed.

2. The audio processing method according to claim 1, wherein
in each stage of the adaptive notch filter processing, a frequency of a stopband is controlled in accordance with an output signal of each stage of the adaptive notch filter processing such that the frequency of the stopband approaches a frequency of non-percussive components in an input signal that is processed by each stage of the adaptive notch filter processing.

3. The audio processing method according to claim 2, wherein
the non-harmonic components contain a plurality of harmonic components, and
the frequency of the stopband is controlled such that the frequency of the stopband approaches a frequency corresponding to one of the plurality of harmonic components, in each stage of the adaptive notch filter processing.

4. The audio processing method recited in claim 3, wherein
the frequency of the stopband in each stage of the adaptive notch filter processing is controlled such that frequencies of a plurality of stopbands that includes the stopband are arranged on a frequency axis at equal intervals, and the plurality of stages of adaptive notch filter processing have the plurality of stopbands, respectively.

5. The audio processing method according to claim 1, further comprising
subtracting the second audio signal from the first audio signal, thereby generating a third audio signal.

6. An audio processing method realized by a computer system, the method comprising:
generating, from a first audio signal containing percussive components and non-percussive components, a first band signal in a first frequency band, and a second band signal in a second frequency band that is different from the first frequency band;
serially executing a plurality of stages of first adaptive notch filter processing on the first band signal, thereby generating a third band signal in which the non-percussive components in the first band signal are suppressed;
serially executing a plurality of stages of second adaptive notch filter processing on the second band signal, thereby generating a fourth band signal in which the non-percussive components in the second band signal are suppressed; and
synthesizing the third band signal and the fourth band signal, thereby generating a second audio signal.

7. The audio processing method according to claim 6, wherein
the first frequency band is lower than the second frequency band, and
the number of the plurality of stages of the first adaptive notch filter processing is greater than the number of the plurality of stages of the second adaptive notch filter processing.

8. An audio processing system comprising:
an electronic controller including at least one processor configured to
acquire a first audio signal including percussive components and non-percussive components, and
serially execute a plurality of stages of adaptive notch filter processing on the first audio signal, thereby generating a second audio signal in which the non-percussive components in the first audio signal are suppressed.

9. The audio processing system according to claim 8, wherein
the at least one processor is configured to control a frequency of a stopband in accordance with an output signal of each stage of the adaptive notch filter processing such that the frequency of the stopband approaches a frequency of non-percussive components in an input signal that is processed by each stage of the adaptive notch filter processing.

10. The audio processing system according to claim 9, wherein
the non-harmonic components contain a plurality of harmonic components, and
the at least one processor is configured to control the frequency of the stopband such that the frequency of the stopband approaches a frequency corresponding to one of the plurality of harmonic components, in each stage of the adaptive notch filter processing.

11. The audio processing system recited in claim 10, wherein
the at least one processor is configured to control the frequency of the stopband in each stage of the adaptive notch filter processing such that frequencies of a plurality of stopbands that includes the stopband are arranged on a frequency axis at equal intervals, and the plurality of stages of adaptive notch filter processing have the plurality of stopbands, respectively.

12. The audio processing system according to claim 8, wherein
the at least one processor is further configured to subtract the second audio signal from the first audio signal, thereby generating a third audio signal.

13. A non-transitory computer-readable medium storing a program that causes a computer system to execute a process, the process comprising:
acquiring a first audio signal including percussive components and non-percussive components; and
serially executing a plurality of stages of adaptive notch filter processing on the first audio signal, thereby generating a second audio signal in which the non-percussive components in the first audio signal are suppressed.
